(19) United States
(12) Patent Application Publication
(10) Pub. No.: US 2004/0266499 A1
(43) Pub. Date: Dec. 30, 2004

(54) Portable electronic apparatus

(75) Inventor: Akinobu Sawada, Kyoto (JP)

Correspondence Address: MORGAN LEWIS & BOCKIUS LLP, 1111 PENNSYLVANIA AVENUE NW, WASHINGTON, DC, 20004, US

(73) Assignee: ROHM CO., LTD

(21) Appl. No.: 10/814,869

(22) Filed: Apr. 1, 2004

(30) Foreign Application Priority Data
Apr. 2, 2003 (JP) P 2003-099165

(51) Int. Cl. H04M 1/00

(52) U.S. Cl. 455/575.6; 455/550.1

(57) ABSTRACT

One instruction sent from a control section such as a CPU is supplied to a plurality of sensory output means in common at the same time or an operation command signal to be sent to a controller for sensory means is formed by phenomenon detecting means based on a driving signal sent from another controller for sensory means. Thus, a plurality of sensory output means is reliably driven synchronously.

### BACKGROUND OF THE INVENTION

1. Field of the Invention

The present invention relates to a portable electronic apparatus such as a portable telephone and more particularly to a portable electronic apparatus for operating a plurality of sensory output devices at the same time.

2. Description of the Related Art

A portable electronic apparatus has such a structure that an owner thereof can feel the output states of a video, a voice and a vibration by a visual sense, an auditory sense or a tactile sense.

For example, in a portable telephone, predetermined music data are reproduced or a vibration or a light is generated to give a notice of an incoming call at time of the incoming call. In some cases, a plurality of notices for the incoming call to be given by the music, the vibration or the light is generated at the same time.

Conventionally, such data to be given are stored as voice data, vibration data and display data in reproducing data storing means, and are read from the reproducing data storing means in accordance with a predetermined timing signal by reproducing control means such as a CPU, thereby carrying out a control in such a manner that the data can be synchronously reproduced, respectively. Consequently, it has been known that the voice data, the vibration data and the display data are reproduced synchronously as disclosed in JP A 2001-228872.

In order to obtain different display control information from original melody information synchronously with a melody, moreover, data for the melody to generate a sound by a melody sound source are read from a memory by the control of a control section and are output to the melody sound source, thereby generating and amplifying the waveform of the melody and generating a sound from a speaker when the sound of the melody is to be generated. Simultaneously with the melody generating, an LED driving signal is output from the melody sound source so that an LED emits a light by an LED driving circuit. Similarly, it has been known that a vibrator driving signal is output from the melody sound source, thereby vibrating a vibrator by means of a vibrator driving circuit to vibrate a housing as disclosed in JP A 2002-111795.

In the method as disclosed in JP A 2001-228872, it carries out a control so as to store voice data, vibration data and display data in the reproducing data storing means, and its reproducing control means, such as a CPU, reads them out to reproduce the respective reproducing data. However, in a case of high-degree job traffic in the CPU, it is likely that a time difference might be made on each of the commands of the voice data, the vibration data and the display data, due to the generation of the interrupting signal by the job that is given the high priority, in spite of those commands being to be executed sequentially. As the result, the user might feel something wrong from one's natural feeling. If a high-grade CPU with a high processing speed can be adopted, this problem might be resolved. However, it is rather difficult to adopt a high-grade CPU, which is capable of carrying out a high-speed processing in a portable telephone, under a cost constraint such as need to reduce the manufacturing cost as much as possible and, at the same time, current consumption is also needed to be decreased. For this reason, it is difficult to reproduce each of the data synchronously without any time difference.

In the method as disclosed in JP A 2002-111795, in which the data for a melody read by the control section are supplied to the melody sound source to generate the waveform of the melody, and the data for the melody are also supplied to the LED driving circuit and the vibrator driving circuit to output the LED driving signal and the vibrator driving signal, it is moreover required to provide the LED driving circuit and the vibrator driving circuit with an advanced functionality to analyze the data for the melody.

### SUMMARY OF THE INVENTION

Therefore, it is an object of the invention to provide a portable electronic apparatus capable of operating a plurality of sensory output devices such as for a video, a voice and a vibration at the same time with a simple structure without increasing the burden of a control section such as a CPU.

Moreover, it is another object of the invention to provide a portable electronic apparatus which can also utilize the device controlling a plurality of sensory outputs, such as a video output, a voice output and a vibration output, for a welfare aid purpose for a visually handicapped people.

A first aspect of the invention is directed to a portable electronic apparatus comprising control means including a CPU, a plurality of sensory output means for outputting different types of human sensible information, and a plurality of controllers for sensory means of different types which outputs a driving signal to each of the sensory output means upon receipt of an operation command signal sent from the control means,

wherein the control means sends an operation command signal indicative of an identical specific phenomenon to the controllers for sensory means in common, and

the controllers for sensory means form driving signals which are unique but are corresponding to the operation command signal indicative of the identical specific phenomenon respectively and output the same driving signals to the sensory output means corresponding thereto, thereby carrying out a synchronous operation.

A second aspect of the invention is directed to the portable electronic apparatus according to the first aspect of the invention, wherein the sensory output means include display means, voice output means and vibrating means, and the controllers for sensory means include a display controller for the display means, a voice controller for the voice output means, and a vibration controller for the vibrating means.

A third aspect of the invention is directed to a portable electronic apparatus comprising control means including a CPU, first to Nth (N is an integer of 2 or more) for outputting different types of human sensible informaiton, a plurality of controllers for sensory means of different types which outputs a driving signal to each of the sensory output means upon receipt of an operation command signal sent from the control means, and first phenomenon detecting means for creating an operation command signal indicative of a specific phenomenon based on a driving signal of the first controller for sensory means from the same driving signal and outputting the same operation command signal to at least the second controller for sensory means,

wherein the control means sends an operation command signal indicative of a specific phenomenon to the first controller for sensory means,

the first controller for sensory means supplies a driving signal representing the specific phenomenon to the first sensory output means,

at least the second controller for sensory means forms a driving signal representing the specific phenomenon upon receipt of the operation command signal indicative of the specific phenomenon which is detected by the first phenomenon detecting means, and supplies the driving signal representing the specific phenomenon to the second sensory output means, and

at least the corresponding first and second sensory output means are operated synchronously.

A fourth aspect of the invention is directed to the portable electronic apparatus according to the third aspect of the invention, wherein the first sensory output means is display means, the second sensory output means is voice output means or vibrating means, the first controller for sensory means is a display controller for the display means, and the second controller for sensory means is a voice controller for the voice output means or a vibration controller for the vibrating means.

A fifth aspect of the invention is directed to the portable electronic apparatus according to the fourth aspect of the invention, further comprising image pick-up means for supplying photographed video data to the display controller,

the first phenomenon detecting means detecting a specific phenomenon related to the video data from a driving signal of the display controller based on the video data transmitted from the image pick-up means and outputting an operation command signal indicative of the specific phenomenon to the voice controller or the vibration controller which serves as the second sensory controller, and

the voice controller or the vibration controller which serves as the second sensory controller supplying a driving signal representing the specific phenomenon to the voice output means or the vibrating means.

### BRIEF DESCRIPTION OF THE DRAWINGS

FIG. 1 is a diagram showing the structure of a portable electronic apparatus according to a first embodiment of the invention,

FIG. 2 is a diagram showing the structure of a portable electronic apparatus according to a second embodiment of the invention, and

FIG. 3 is a diagram showing the structure of a portable electronic apparatus according to a third embodiment of the invention.

### DESCRIPTION OF THE PREFERRED EMBODIMENTS

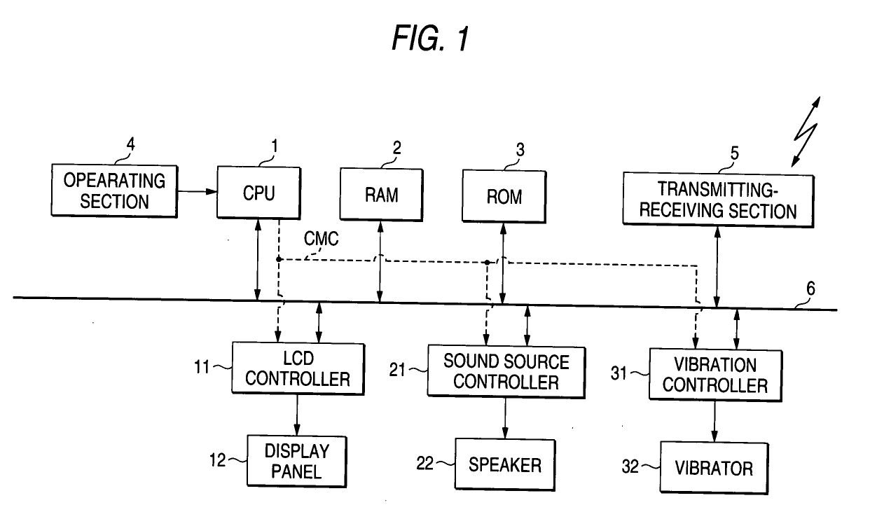

Embodiments of a portable electronic apparatus according to the invention will be described below with reference to the drawings. FIG. 1 is a diagram showing the structure of a portable electronic apparatus according to a first embodiment of the invention, which will be described below by taking a portable telephone as an example.

In FIG. 1, a CPU 1 is functioning as control means to control over the whole portable telephone, RAM 2 is storage means to be a temporary memory for storing data to be output and a work memory for a control, and ROM 3 is a fixed memory for storing data to be utilized fixedly or storing means for storing program data.

An operating section 4 is provided with operating switches such as a keyboard where the signal corresponding to the operation thereof might be supplied to the CPU 1 . A transmitting-receiving section 5 carries out a communication together with an external base station. These are coupled through a bus line 6.

An LCD controller 11 is one of controllers used for sensory means which is operated in response to an operation display command signal which is sent from the CPU 1, and outputs a driving signal for the display of an LCD display panel 12 acting as display means to be one of sensory output means. The LCD controller 11 can be constituted by a display driver IC to be used usually which comprises an external I/F circuit, a display control section, a circuit for generating a driving voltage and a liquid driving circuit. Similarly, other controllers can be constituted by a driver IC for a sound source or a vibration which is usually used.

A sound source controller 21 is one of the controllers for sensory means and is operated in response to an operation command signal for a voice which is sent from the CPU 1, and outputs a driving signal for outputting a voice from a speaker 22 acting as voice output means to be one of sensory output means.

A vibration controller 31 is one of the controllers for sensory means and is operated in response to an operation command signal for a vibration which is sent from the CPU 1, and outputs a driving signal for the vibration of a vibrator 32 acting as vibrating means to be one of the sensory output means.

While various other components are added to the portable telephone, those not directly related to description for this invention will be omitted but might not deny any possibility of taking various other components.

In the portable telephone, during a normal operation, an operation command signal for a display which serves to cause the display panel 12 to carry out a display is supplied from the CPU 1 to the LCD controller 11, and the LCD controller 11 generates a driving signal for a display in response to the operation command signal for a display. Also in the sound source controller 21, the speaker 22, the vibration controller 31 and the vibrator 32, similarly, this operation is carried out in response to the operation command signal for a voice and the operation command signal for a vibration which are sent from the CPU 1, respectively.

At a time of an incoming call coming, the display panel 12, the speaker 22 and the vibrator 32 might be driven at the same time according to the incoming call and any operation state (a display, a voice or a vibration) can be felt sensorily so as to recognize the presence of the incoming call. Although it is desirable that the operations of the display panel 12, the speaker 22 and the vibrator 32 in the incoming call should be perfectly synchronous with each other, however to the extend such that recognizing any of the operation states should be acceptable, it is sufficient that they might be almost synchronous with each other.

In a recent portable telephone, many other functions have been introduced. As an example, the function of a game machine is put into the portable telephone

In the case in which the portable telephone is used as the game machine, it is required that the display panel 12, the speaker 22 and the vibrator 32 are synchronized with each other in order to make the sensory feeling to be synchronized as human sensible information in response to a specific phenomenon when the specific phenomenon is generated, whereby virtual excitement of the game might be enhanced. An explosion scene, a hitting scene or other scenes with a sudden motion change might be considered as the specific phenomenon, for example.

The explosion scene will be supposed as the specific phenomenon in the following description. In the first embodiment shown in FIG. 1, a common operation command signal CMC is generated, in the CPU 1, as one common instruction representing an explosion, and is simultaneously supplied to the LCD controller 11, the sound source controller 21 and the vibration controller 31 through the bus line 6. The common operation command signal CMC is shown in a broken line having an arrow in the drawing.

Upon receipt of the common operation command signal CMC representing the explosion, the LCD controller 11 generates a driving signal for displaying an explosion scene and supplies the same driving signal to the display panel 12. Similarly, the sound source controller 21 and the vibration controller 31 generate driving signals for a voice output and a vibration output corresponding to the explosion scene respectively, and supply the same driving signals to the speaker 22 and the vibrator 32.

According to the first embodiment, it is sufficient that one common instruction representing the explosion is output from the CPU 1 irrespective of the number of the sensory output means representing the explosion scene. Even if the level of the job traffic in the CPU 1 is very high, a plurality of sensory output means can reliably be driven synchronously.

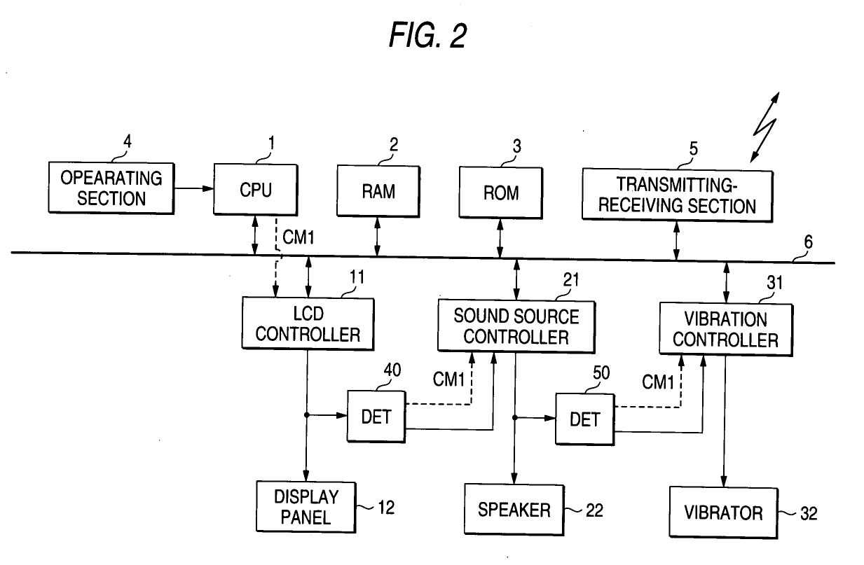

FIG. 2 is a diagram showing the structure of a portable electronic apparatus according to a second embodiment of the invention, which will be described below by taking a portable telephone as an example.

In FIG. 2, in the second embodiment, the first phenomenon detecting means 40 and the second phenomenon detecting means 50 are provided. In this second embodiment, it is different from the first embodiment as already described in FIG. 1 in the first phenomenon detecting means 40, the second phenomenon detecting means 50, and the related structures thereof.

The first phenomenon detecting means 40 creates an operation command signal CM1 indicative of a specific phenomenon (for example, an explosion) to be a basis of a driving signal output from an LCD controller 11 based on the same driving signal, and outputs the operation command signal CM1 to a sound source controller 21. The operation command signal CM1 is shown in a broken line having an arrow in the drawing. The sound source controller 21 generates a driving signal for a voice which represents a specific phenomenon (for example, an explosion) to a speaker 22 upon receipt of the operation command signal CM1.

The second phenomenon detecting means 50 also creates an operation command signal CM1 indicative of a specific phenomenon (for example, an explosion) to be a basis of a driving signal output from the sound source controller 21 based on the same driving signal, and outputs the operation command signal CM1 to a vibration controller 31. The vibration controller 31 generates a driving signal for a vibration which represents a specific phenomenon (for example, an explosion) to a vibrator 32 upon receipt of the operation command signal CM1.

The first phenomenon detecting means 40 and the second phenomenon detecting means 50 can be constituted to include a decoder for generating an output being decoded to correspond to a specific phenomenon to be a basis of the driving signals of a video or that of a voice, those which represent the corresponding luminance value or the corresponding volume thereof or some other specific patterns thereof.

In the second embodiment shown in FIG. 2, similarly, an explosion scene will be considered as the specific phenomenon. The operation command signal CM1 is generated, in a CPU 1, as one instruction representing an explosion and is supplied to only the LCD controller 11 through a bus line 6.

Upon receipt of the operation command signal CM1 representing the explosion, the LCD controller 11 generates a driving signal for displaying an explosion scene and supplies the same driving signal to a display panel 12, and the display panel 12 displays the explosion scene.

At this time, a driving signal for displaying the explosion scene is detected by the first phenomenon detecting means 40, and an operation command signal CM1 corresponding to the explosion scene is generated and is supplied to the sound source controller 21. A driving signal for a voice corresponding to the explosion scene is generated in the sound source controller 21 and is supplied to the speaker 22, and a voice corresponding to the explosion scene is output from the speaker 22.

Moreover, a driving signal for outputting a voice for the explosion scene is detected by the second phenomenon detecting means 50, and an operation command signal CM1 corresponding to the explosion scene is generated and is supplied to the vibration controller 31. A driving signal for a vibration corresponding to the explosion scene is generated in the vibration controller 31 and is supplied to the vibrator 32, and a vibration corresponding to the explosion scene is output from the vibrator 32.

While the first phenomenon detecting means 40 and the second phenomenon detecting means 50 are used in FIG. 2, it is also possible to supply the operation command signal CM1 sent only from the first phenomenon detecting means 40 to the sound source controller 21 and the vibration controller 31, thereby omitting the second phenomenon detecting means 50.

According to the second embodiment, it is sufficient that the operation command signal CM1 to be one instruction representing the explosion is output from the CPU 1 to the LCD controller 11 irrespective of the number of sensory output means representing the explosion scene. The operation command signal CM1 indicative of a specific phenomenon (the explosion) to be a basis of a driving signal for a display output from the LCD controller 11 is created from the same driving signal, and outputs the operation command signal CM1 to the sound source controller 21 to be another controller for sensory means. Furthermore, the operation command signal CM1 indicative of the specific phenomenon (the explosion) to be the basis of the driving signal for a voice output from the sound source controller 21 is created from the same driving signal, which is output to the vibration controller 31 to be another controller for sensory means.

Thus, the operation command signal CM1 to be sent to one controller for sensory means is formed based on the driving signal output from another controller for sensory means. Even if the level of the job traffic in the CPU 1 is very high, a plurality of sensory output means can reliably be driven synchronously.

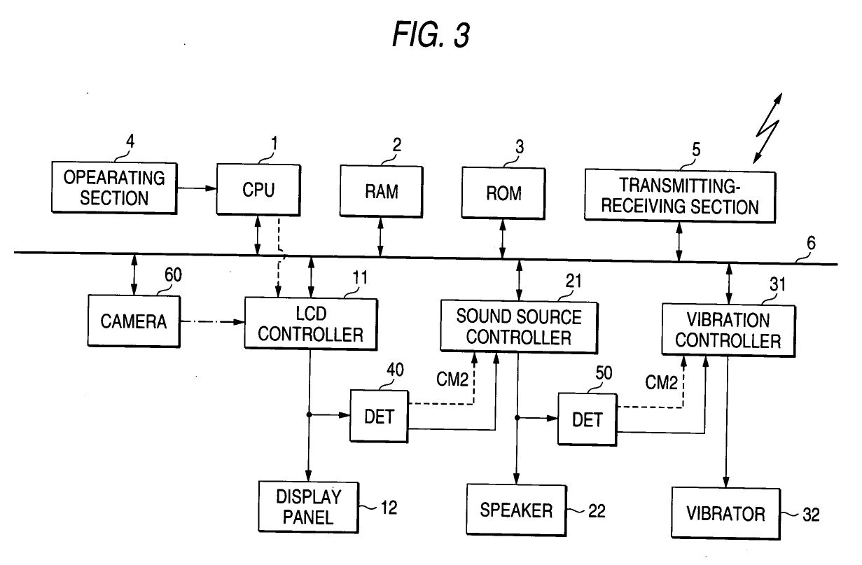

FIG. 3 is a diagram showing the structure of a portable electronic apparatus according to a third embodiment of the invention, which will be described below by taking a portable telephone as an example.

In FIG. 3, a camera 60 as an image pick-up device is provided, which is different aspect from the second embodiment as shown in FIG. 2. The video data of the camera 60 are directly supplied to an LCD controller 11 without using a CPU 1. The video data of the camera 60 are also supplied to RAM 2 and are stored to be transmitted to an outside through a transmitting-receiving section 5. In other respects, the third embodiment has the same structures as those in the second embodiment shown in FIG. 2.

In FIG. 3, in the case in which the owner of the portable telephone walks while photographing a scene in the direction of advance by means of the camera 60, for example, video data in the direction of advance are sequentially supplied from the camera 60 to the LCD controller 11 and a driving signal for a display based on the video data is supplied from the LCD controller 11 to a display panel 12.

The driving signal for a display includes specific phenomena such as the brightness of a place in a scene photographed by the camera 60, the degree of approach of an object, the degree of a jam on a circumference and the speed of their change.

The specific phenomena are detected based on the luminance value of a driving signal for a video corresponding thereto, the specific pattern of a video or their temporal change by first phenomenon detecting means 40.

An operation command signal CM2 decoded to correspond to the specific phenomenon detected by the first phenomenon detecting means 40 is supplied to a sound source controller 21 and a vibration controller 31 in the same manner as in FIG. 2. Consequently, a notice can be given to the owner in a voice and a vibration from a speaker 22 and a vibrator 32 in addition to the display panel 12 according to the scene photographed by the camera 60 and the change thereof.

The portable telephone according to the third embodiment shown in FIG. 3 functions particularly effectively if the owner is a visually handicapped person.

When the visually handicapped person walks with taking the real-time image of a forward part by the camera 60 of the portable telephone, the operation command signal CM2 might be generated in accordance with the presence of the obstacle, being sensed in the forward part, that might be disturbing his walking so that an alarm sound is generated from the speaker 22, and/or an alarm vibration is generated from the vibrator 32.

In this way, the visually handicapped person can perceive the presence of the obstacle through the alarm sound and the alarm vibration and can avoid a danger in advance. Consequently, the portable telephone can be used effectively as an apparatus for welfare.

According to the invention, in a portable electronic apparatus such as a portable telephone, a plurality of sensory output devices for a video, a voice and a vibration is reliably operated simultaneously by only one instruction sent from a control section such as a CPU. Accordingly, it is possible to implement a plurality of sensory synchronizations with a simple structure without increasing the burden of the control section such as the CPU and using a high-grade CPU.

Moreover, it is possible to reliably drive a plurality of sensory output means synchronously by simply supplying only one instruction from the control section such as a CPU to the sensory output means in common at the same time.

In addition, an operation command signal to be sent to a controller for sensory means is formed by phenomenon detecting means based on a driving signal sent from another controller for sensory means. Therefore, a plurality of sensory output means can reliably be driven synchronously.

Furthermore, image pick-up means for supplying the captured video image data to a controller for a display is provided and an operation command signal to be sent to another controller for a voice or a vibration is formed by the phenomenon detecting means based on a driving signal sent from the controller for a display. Consequently, the portable electronic apparatus can also be used effectively as an apparatus for the welfare of visually handicapped people.

What is claimed is:

1. A portable electronic apparatus comprising:
control means including a CPU;
a plurality of sensory output means for outputting human sensible information, and
a plurality of controllers for sensory means which output driving signals to said plurality of the sensory output means respective thereof upon receipt of an operation command signal sent from the control means,
wherein said control means sends an operation command signal indicative of a specific phenomenon to said plurality of controllers for sensory means in common, and
further wherein, each controller of said plurality of controllers for sensory means forms a driving signal that is unique for said each controller in connection with the operation command signal indicative of said specific phenomenon, and output said driving signal to the sensory output means respective thereof, whereby said plurality of sensory output means carry out a synchronous operation there between.

2. The portable electronic apparatus according to claim 1, wherein said plurality of sensory output means include at least display means, voice output means and vibrating means, and further wherein said plurality of controllers for sensory means include at least a display controller for the display means, a voice controller for the voice output means, and a vibration controller for the vibrating means.

3. A portable electronic apparatus comprising:
control means including a CPU;
a plurality of sensory output means of first type to Nth type(N is an integer of 2 or more) for outputting human sensible information;
a plurality of controllers for sensory means which output driving signals to said plurality of the sensory output means respective thereof upon receipt of an operation command signal sent from the control means, and
first phenomenon detecting means for generating an operation command signal that is indicative of a specific phenomenon from which a driving signal of the first controller for sensory means is produced, said operation command signal being output to at least the second controller for sensory means,
wherein said control means sends an operation command signal indicative of a specific phenomenon to said first controller for sensory means, whereby the first controller for sensory means supplies a driving signal representing said specific phenomenon to the first sensory output means further wherein at least the second controller for sensory means forms another driving signal representing said specific phenomenon upon receipt of the operation command signal indicative of the specific phenomenon which is detected by the first phenomenon detecting means, said another driving signal being supplies to the driving signal representing the specific phenomenon to the second sensory output means, and
at least the corresponding first and second sensory output means are operated synchronously there between.

4. The portable electronic apparatus according to claim 3, wherein the first sensory output means is display means, the second sensory output means is voice output means or vibrating means, further wherein the first controller for sensory means is a display controller for the display means, and the second controller for sensory means is a voice controller for the voice output means or a vibration controller for the vibrating means.

5. The portable electronic apparatus according to claim 4, further comprising image pick-up means for supplying video data to the display controller,
the first phenomenon detecting means detecting a specific phenomenon from a driving signal formed by the display controller in connection with the video data transmitted from the image pick-up means, said specific phenomenon being detected based upon said video data so as to output an operation command signal indicative of the specific phenomenon to the voice controller or the vibration controller which serves as the second sensory controller, whereby another driving signal representing the specific phenomenon is supplied to the voice output means or the vibrating means respectively.
